(19) United States
(12) Patent Application Publication
(10) Pub. No.: US 2010/0132242 A1
(43) Pub. Date: Jun. 3, 2010

(54) EVENT TRIGGERING CLOSEABLE NET

(76) Inventor: James Emter, Jr., Ridgefield, WA (US)

Correspondence Address: RYLANDER & ASSOCIATES PC, P.O. Box 250, VANCOUVER, WA, 98660, US

(21) Appl. No.: 12/618,172

(22) Filed: Nov. 13, 2009

Related U.S. Application Data
(60) Provisional application No. 61/114,841, filed on Nov. 14, 2008.

(51) Int. Cl. A01K 77/00

(52) U.S. Cl. 43/11

(57) ABSTRACT

An embodiment of the invention is a net that is closable to substantially impede the unintentional release of a fish or other creature that is releasably contained therein.

### CROSS-REFERENCE TO RELATED APPLICATION

This application claims priority to co-pending provisional application Ser. No. 61/114,841 filed 14 Nov. 2008 and is incorporated herein by reference.

### FIELD OF THE INVENTION

The present invention relates to selectively closeable fishing nets.

### BACKGROUND

Recreational, sport, and competitive fishing is a popular pastime and/or source of employment. Regardless of fishing lure or fishing species, one of the most important aspects of fishing is landing the fish once it has been hooked. Traditionally, to do so involves the use of a landing net assembly generally including a handle, a frame coupled to the handle, and a net suspended from the frame. Utilizing the handle, an angler may scoop up or otherwise releasably capture a fish within the net. A net may further impede the unintentional release (e.g., by changing shape and/or configuration) of the fish. The angler may thereafter retrieve the releasably captured fish from the net.

A number of devices or assemblies have provided a fishing net including a configuration to impede the unintentional release of a fish captured therein. Presently known art attempts to address this problem, but has not completely solved the problem. The following represents a list of known related art:

| | | Date of |
|---|---|---|
| Reference: | Issued to: | Issue/Publication: |
| U.S. Pat. No. 4,272,906 | Liebling | Jun. 16, 1981 |
| U.S. Pat. No. 4,516,347 | Dickie | May 14, 1985 |
| U.S. Pat. No. 6,446,378 | Welch et al. | Sep. 10, 2002 |
| U.S. Pat. No. 6,796,075 | Maguire et al. | Sep. 28, 2004 |
| US Patent Pub 2002/0139032 | Campbell | Oct. 3, 2002 |

The teachings of each of the above-listed citations (which does not itself incorporate essential material by reference) are herein incorporated by reference. None of the above inventions and patents, taken either singularly or in combination, is seen to describe the instant invention as claimed.

For example, U.S. Pat. No. 4,272,906 to Liebling teaches a closeable fishing net including a frame a U-shaped portion beneath which a container is suspended in which a fish may be contained. A cover is slidably supported by the U-shaped portion for movement between a retracted position in which the opening for the fish is open and an extended position in which the opening is closed.

U.S. Pat. No. 4,516,347 to Dickie teaches a net structure including a handle having a rigid hoop secured thereto. A flexible bag having an openable top portion defining the mouth of the bag has a plurality of connector means secured at spaced intervals thereto. These connector means are also freely slidably attached to the rigid hoop to pendantly secure the bag to the hoop. These connector means are moveable from a relative positional arrangement wherein they are spaced apart about the hoop to define the open mouth position of the bag to a second relative positional arrangement wherein such connector means are grouped together on the hoop to define the closed mouth position of the bag.

U.S. Pat. No. 6,796,075 to Maguire et al. teaches a retractable fishing net includes a handle, a retraction mechanism, a net support band and a netting. The handle has a grip end and a net end. The retraction mechanism is slidably mounted on the handle, the retraction mechanism being movable between the grip end and the net end. The net support band is mounted relative to the handle and the retraction mechanism in a manner so as to provide the net support band with a spring quality, the spring quality of the net support band acting to bias the retraction mechanism toward the net end of the handle. The netting is mounted on the net support band.

However, there is a need for a fishing net that has an improved structure, configuration, and method to impede the unintentional release of a releasably captured fish.

Similarly, such a net would be useful for capturing other creatures, such as animals, birds, butterflies, among others.

### SUMMARY AND ADVANTAGES

An embodiment of the invention is a net that is closable upon occurrence of a triggering event to substantially impede the unintentional release of a fish that is releasably contained therein.

The event triggering closeable net of an embodiment of the present invention presents numerous advantages, including: (1) substantial prevention of accidental or inadvertent release of a fish, or other creature, captured in the net; (2) quick operation once a fish has been captured in the net; (3) lockable in the closed position for further substantial prevention of accidental or inadvertent release of a fish captured in the net; (4) quick release/conversion to open position for fish entry and exit; (5) easier stowage in closed position; and (6) unlike most fishing nets on the market, the disclosed net does not need to be so deep because the user does not have to worry about the fish escaping once inside the net, making it less likely for the net to get caught on something in the boat while trying to fish.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows the net assembly of an embodiment in a closed configuration.

FIG. 2 shows the net assembly of FIG. 1 in an open configuration.

FIG. 3 shows the net assembly of another embodiment in a closed configuration.

FIG. 4 shows the net assembly of FIG. 3 in an open configuration.

FIG. 5 shows the net assembly of another embodiment in open configuration.

FIG. 6 shows the net assembly of FIG. 5 in a closed configuration.

FIG. 7 shows the net assembly of FIG. 5 in a closed configuration.

FIG. 8 shows the net assembly of another embodiment in a closed configuration.

FIG. 9 shows the net assembly of another embodiment in a closed configuration.

FIG. 10 shows the net assembly of FIG. 9 in an open configuration.

FIG. 11 shows the net assembly of another embodiment in a closed configuration.

FIG. 12 shows the net assembly of FIG. 11 in an open configuration.

### REFERENCE NUMBERS USED IN DRAWINGS

Turning now descriptively to the drawings, in which similar reference characters denote similar elements throughout the several views, the figures illustrate the net assembly of the present invention. With regard to the reference numerals used, the following numbering is used throughout the various drawing figures:

10 Net Assembly

20 Handle Portion

21 Resilient Member Attachment Portion

22 Collar

23 Collar Guide

24 Locking Member

25 Resilient Member Guide

26 Channel

27 Collar Channel

30 Frame Portion

40 Net Portion

42 Bag

44 Frame Attachment Portion

46 Net Aperture

50 Resilient Member

52 Resilient Member Loop

110 Net Assembly of another embodiment

120 Handle Portion of another embodiment

122 Handle Channel of another embodiment

124 Collar of another embodiment

126 Locking Member of another embodiment

130 Resilient Frame Portion of another embodiment

140 Net Portion of another embodiment

142 Bag Portion of another embodiment

144 Resilient Frame Attachment Portion of another embodiment

146 Net Aperture of another embodiment

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Simply stated, an embodiment of the invention is a net that is closable to substantially impede the unintentional release of a fish, or other creature, that is releasably contained therein.

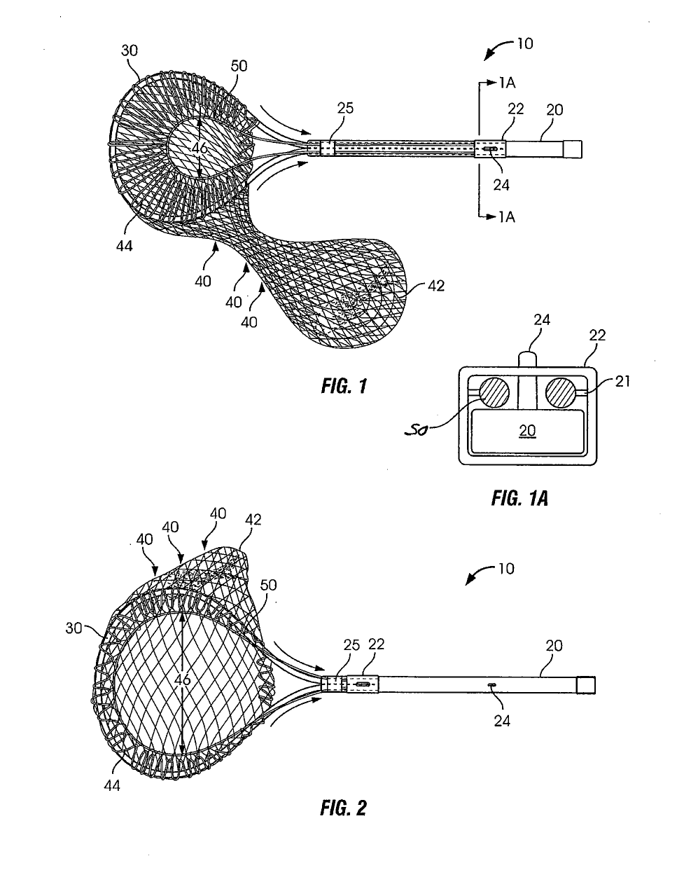

As shown in FIGS. 1-8, a net assembly 10 is provided. As shown in FIGS. 1-8, the net assembly 10 comprises a handle portion 20, a frame portion 30 coupled to the handle portion 20, and a net portion 40 coupled to the frame portion 30. In an embodiment, a resilient member 50 may couple to the net portion and the handle portion 20. More specifically, the resilient member 50 may couple to the handle portion 20 by way of a collar 22 that may slidably engage the handle portion 20 along the length of the handle portion 20. By slidably engaging the handle portion 20 at alternate positions along the length of the handle portion 20, the collar 22 may determine both an open configuration and a closed configuration for net assembly 10. When in the open configuration, the net assembly 10 may scoop up or otherwise releasably capture a fish in the net portion 40. In the closed configuration, the net assembly 10 may substantially impede the unintentional release of a fish that is releasably contained therein.

For example, FIG. 1 illustrates the net assembly 10 in a closed configuration. The resilient member 50 coupled to the frame attachment portion 44 of the net portion 40 may define a net aperture 46 through which a fish, for example, may enter and/or exit the bag 42. When the net assembly 10 is in a closed configuration, the resilient member 50 and frame attachment portion 44 of the net portion 40 may define a narrow and/or substantially constricted net aperture 46 as illustrated.

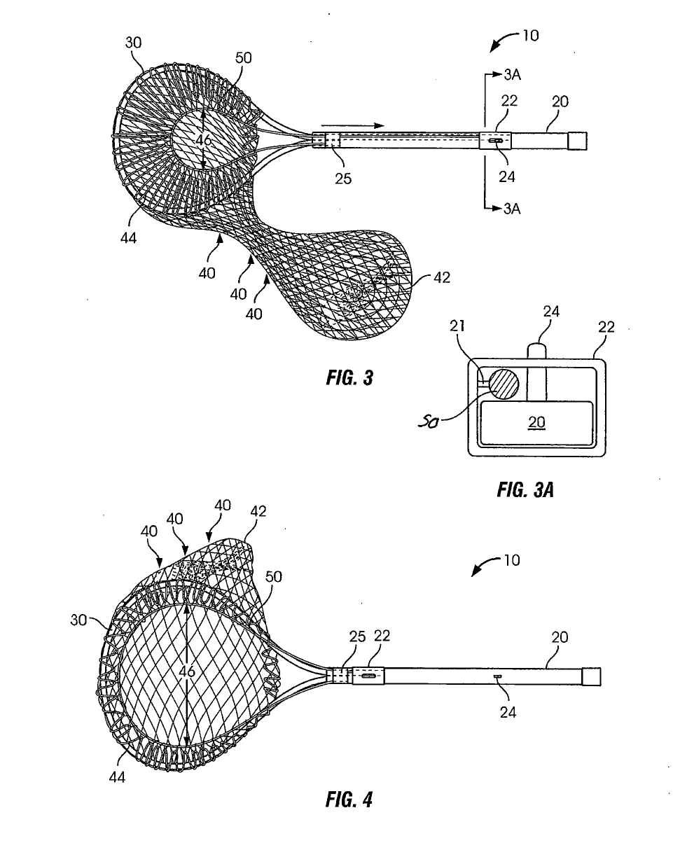

More specifically, in addition to the frame attachment portion 44 of the net portion 40, the resilient member 50 may couple to the collar 22 that may slidably couple to the handle portion 20 of the net assembly 10. In an embodiment, both ends of the resilient member 50 may couple to the collar 22. In particular, as illustrated by FIG. 1A, the resilient member 50 may couple to the collar 22 with a resilient member attachment portion 21. The resilient member attachment portion 21 may include an adhesive joint, weld, and/or a mechanical attachment. Further, in an embodiment, the resilient member 50 may couple to and/or run through a resilient member guide 25. The resilient member guide 25 may couple to or be formed in the handle portion 20 adjacent the frame portion 30 and may include a single channel or aperture through which both ends of the resilient member 50 may run, an individual channel or aperture for each end of the resilient member 50, or an individual channel or aperture for a single end of the resilient member 50 to run as is explained with reference to FIGS. 3 and 4.

The collar 22 of the net assembly 10 in the closed configuration may couple to the handle portion 20 opposite the frame portion 30 (i.e., approximately located adjacent to the distal end of the handle portion 20 with reference to the frame portion 30). Further, when the net assembly 10 is in the closed configuration, the collar 22 may detachably engage a locking member 24 coupled to the handle portion 20 and approximately located adjacent to the distal end of the handle portion with reference to the frame portion 30. The locking member 24 of an embodiment may substantially prevent the collar 22 from sliding along the length of the handle portion 20 while detachably engaged. With the collar 22 is positioned substantially opposite the frame portion 20, the length of the resilient member 50 coupled thereto that defines the net aperture 46 may shorten, which in turn decreases the size of, tightens, and/or constricts the net aperture 46

FIG. 2 illustrates the net assembly 10 in an open configuration. When the net assembly 10 is in an open configuration, the resilient member 50 and frame attachment portion 44 of the net portion 40 may define a wide and/or substantially dilated net aperture 46 as illustrated. More specifically, the collar 22 of the net assembly 10 in the open configuration may couple to the handle portion 20 adjacent to the frame portion 30. With the collar 22 is positioned substantially adjacent to the frame portion 20, the length of the resilient member 50 coupled thereto that defines the net aperture 46 may lengthen, which in turn increases the size of and/or dilates the net aperture 46.

Stated alternatively, the resilient member 50 coupled to the frame attachment portion 44 of net portion 40 may function like a drawstring to loosen and cinch up the frame attachment portion 44. More specifically, the resilient member 50 may loosen and cinch up the frame attachment portion 44 to loosen and cinch up the net aperture 46. Further, the stiffness and/or resilience of the resilient member 50 of an embodiment may contribute to the loosening and/or dilation of the net aperture 46 when the net assembly 10 is in the open configuration. Accordingly, when the net assembly 10 is in the open configuration, the stiffness and/or resilience of the resilient member 50 of an embodiment may contribute to the openness and/or dilation of the net aperture 46. Additionally, the weight of the bag 42, particularly when empty, may pull the frame attachment portion 44 toward the frame portion 30 to further contribute to the openness and/or dilation of the net aperture 46. Accordingly, in the net assembly 10 open configuration, the resilient member 50 may not substantially impede the net assembly's 10 ability to collect, scoop up, or otherwise releasably capture a fish compared to a net assembly with like frame portion 30 size that excludes the resilient member 50.

FIGS. 3 and 4 illustrate the net assembly 10 of an another embodiment. Unlike the embodiment illustrated by FIGS. 1 and 2 for which both ends of the resilient member 50 may couple to the collar 22, FIGS. 3 and 4 illustrate that in an embodiment, only one end of the resilient member 50 may couple to the collar 22. More specifically, as illustrated by FIG. 3A, only one end of the resilient member 50 may couple to the collar 22 via resilient member attachment portion 21. The other end of the resilient member 50 may couple to the handle portion 20. Accordingly, when the net assembly 10 is in the closed position as illustrated by FIG. 3 (i.e., for which the collar 22 is positioned substantially opposite the frame portion 20), the length of the resilient member 50 that defines the net aperture 46 may shorten, which in turn decreases the size of and/or constricts the net aperture 46. As only one end of the resilient member 50 may couple to the collar 22, for a given length of handle portion 20 traversed by the collar 22, the net aperture 46 may decreases the size of, tighten, and/or constrict to a lesser degree than the embodiment (e.g., as illustrated by FIGS. 1 and 2) for which both ends of the resilient member 50 couple to the collar 22. FIG. 4 illustrates the net assembly 10 of FIG. 3 in an open configuration.

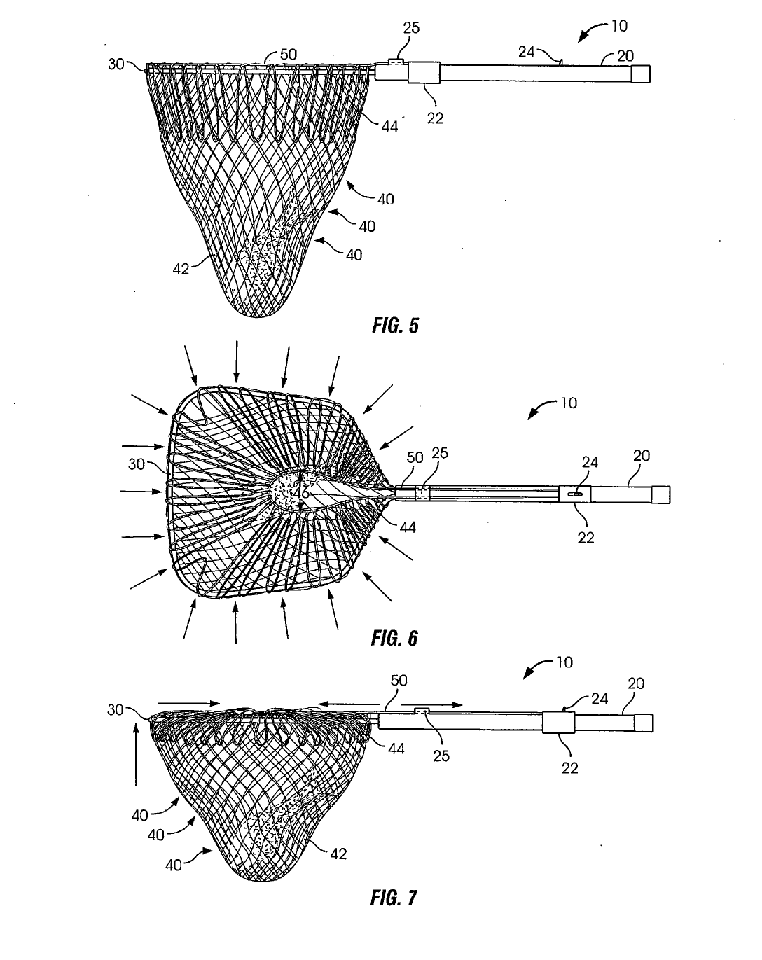

FIGS. 5-7 illustrate the net assembly 10 of another embodiment. The net assembly 10 of this embodiment may substantially resemble and function substantially similarly to the net assembly 10 illustrated by FIGS. 1 and 2 (e.g., both ends of the resilient member 50 couple to the collar 22). The net assembly 10 of this embodiment may further substantially resemble and function substantially similarly to the net assembly 10 illustrated by FIGS. 3 and 4 (e.g., one end of the resilient member couples to the collar 22). Specifically, FIGS. 5-7 illustrate that the frame portion 30 may have an alternate shape. In particular, versus a substantially circular, oval, and/or elliptical shape as illustrated by FIGS. 1-4, the frame portion 30 may have a more angular and/or geometrical shape that may substantially include a plurality of facets. In an embodiment, the frame portion 30 may have a shape that is substantially symmetrical as reflected over a longitudinal axis of the handle portion 20.

For example, the alternate shape for the handle portion 20 may include at least four facets (e.g., at least two facets per side as bisected by the longitudinal axis of the handle portion 20). The alternate shape of the handle portion 20, in an embodiment including a plurality of facets, may serve one or more functions. More specifically, the alternate shape of the handle portion may further control the position and/or size of the net aperture 46 when the net assembly is in both the open and closed configurations. Accordingly, the alternate shape of the frame portion 30 may further increase the size of and/or dilation of the net aperture 46 when the net assembly 10 is in the open configuration. Further, the alternate shape of the frame portion 30 may further decrease the size, constriction, and/or location of the net aperture 46 when the net assembly 10 is in the closed configuration.

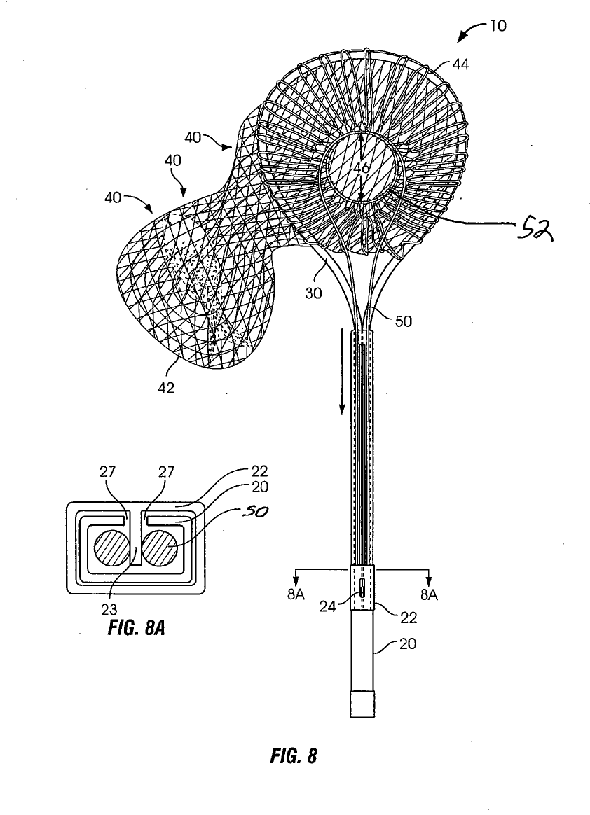

FIG. 8 illustrates yet another embodiment of the net assembly 10. More specifically, FIG. 8 illustrates an embodiment of the net assembly 10 in a closed configuration. Versus resilient member 50, FIG. 8 illustrates resilient member loop 52 that defines the net aperture 46. The resilient member loop 52 may resemble and function similarly to the resilient member 50 with the addition of a loop formed therein. The net aperture 46 defined by the loop formed in the resilient member loop 52 may have a smaller and/or more constricted net aperture 46 when the net assembly 10 is in the closed configuration versus the net assembly 10 including resilient member 50.

FIG. 8A illustrates that the handle portion 20 may include a collar channel 27 into which collar guide 23 may intrude to guide the collar 22 along the handle portion 20. The collar channel 27 length and position along the handle portion 20 may determine the length of resilient member 50 available to define the net aperture 46 when the net assembly 10 is configured as open and closed. The collar guide 23 may further serve as an attachment point for one or both ends of the resilient member 50. One or both ends of the resilient member 50 may attach to the collar guide 23 with an adhesive, a weld, or any other mechanical or chemical attachment methods.

As described with reference to FIGS. 1-8 the resilient member 50 may couple to the collar 22 via resilient member attachment portion 21 at either one or both ends to tighten and loosen (e.g., constrict and dilate the net aperture 46) as the collar 22 slides along the handle portion 20. Generally speaking, the resilient member 50 is coupled to and held in place by the frame attachment portion 44 of the net portion 40. Additionally and/or alternately, a resilient member guide 52 may couple to the handle portion 20 adjacent to the frame portion 40 though which the resilient member 50 may run to control the position of the resilient member 50 as the collar slides along the handle portion. An additional embodiment, though not illustrated, is contemplated. The handle portion 20 may include and/or define one or more channels 26 through which one or both ends of the resilient member 50 may run. The one or more channels 26 may be formed in the exterior of the handle portion 20 and may replace and/or complement the resilient member guide 25 to control the location of the resilient member 50. Alternatively or additionally still, one or both ends of the resilient member 50 may run through an interior of the handle portion 20. For each embodiment, sliding the collar 22 along the handle portion 20 may tighten and loosen the resilient member 50 and accordingly constrict and dilate the net aperture 46 respectively.

In operation in one embodiment, a fisherman or other net assembly 10 user (not illustrated) may store the net assembly 10 and/or prepare the net assembly 10 for use by sliding the collar 22 along the handle portion 20 until it is adjacent to the frame portion 30. By doing so, the fisherman or other user may configure the net assembly 10 in its open configuration. More specifically, by sliding the collar 22 coupled to the resilient member 50 along the handle portion 20 toward the frame portion 30, the fisherman or other user may loosen the resilient member 50 and may open and/or dilate the net aperture 46. Thereafter, the fisherman or other user may net, scoop up, or otherwise releasably capture a fish within the bag 42 of net portion 40. Once the fish has been netted, scooped up, or otherwise releasably captured within the bag 42, the fisherman or other user may slide the collar 22 along the handle portion 20 away from the frame portion 30 to configure the net assembly 10 in its closed configuration. More specifically, by sliding the collar coupled to the resilient member 50 along the handle portion 20 away from the frame portion 30, the fisherman or other user may tighten the resilient member 50 and may close and/or constrict the net aperture 46. The collar 22 may further detachably engage the locking member 24. The fisherman or other user may thereafter handle the net assembly 10 with decreased likelihood that the fish releasably captured therein may escape though the closed and/or constricted net aperture 46.

The net assembly 10 and the components thereof may be formed of a variety of materials. For example, the handle portion 20 and the frame portion 30 may be formed of aluminum, glass fiber reinforced plastic, a glass fiber reinforced polymer, a carbon fiber reinforced plastic, a carbon fiber reinforced polymer, and/or a combination thereof. The net portion 40 may be formed of a synthetic polymer, a polyamide, an ultra high molecular weight polyethylene, or any other material suitable for the net portion 40 as understood in the art. The resilient member 50 and/or the resilient member loop may be formed of a wire rope, glass fiber reinforced plastic, a glass fiber reinforced polymer, a carbon fiber reinforced plastic, a carbon fiber reinforced polymer, and/or a combination thereof.

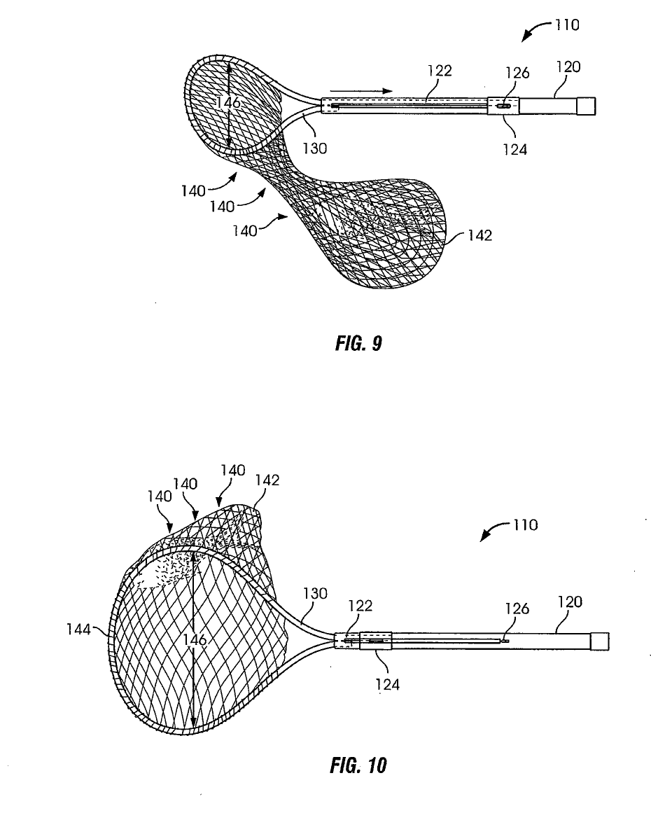

FIGS. 9-13 illustrate the net assembly 110 of yet another embodiment. The net assembly 110 of an embodiment may include a handle portion 120, a collar 124 slidably engaged to the handle portion 120 to slide along the exterior of the handle portion 120 along the longitudinal axis of the handle portion 120, and a resilient frame portion 130 coupled to the handle portion 120 and/or the collar 124. In an embodiment, the handle portion 120 may include and/or define a handle channel 122 to guide the resilient frame portion 130. A net portion 140 including a bag portion 142 may couple to the resilient frame portion 130 with a resilient frame attachment portion 144. The resilient frame portion 130 may define a net aperture 146 through which a fish may releasably enter and exit the net assembly 110.

As described with reference to FIGS. 1-8 illustrating net assembly 10, the net assembly 110 may have an open configuration and a closed configuration. In the open configuration, the net aperture 146 may be dilated or otherwise of sufficiently large size to permit a fish to enter the net portion 140 without substantial impediment. Once the fish has been releasably captured in the net portion 140, the net assembly 110 maybe converted to a closed configuration. In the closed configuration, the net aperture 146 may be constricted or otherwise of a sufficiently small size to substantially impede the fish from escape and/or unintentional release from the net portion 140.

In particular, the net aperture 146 of an embodiment may be altered by altering the resilient frame portion 130. For example, as noted the resilient frame portion 130 may couple to the collar 124 that is in turn slidably engaged to the handle portion 120. More specifically, the resilient frame portion 130 may couple to the collar 124 at one or both of its ends to form a loop in the resilient frame portion 130. Accordingly, the loop formed in the resilient frame portion 130 protruding from the handle portion 120 may further define the net aperture 146.

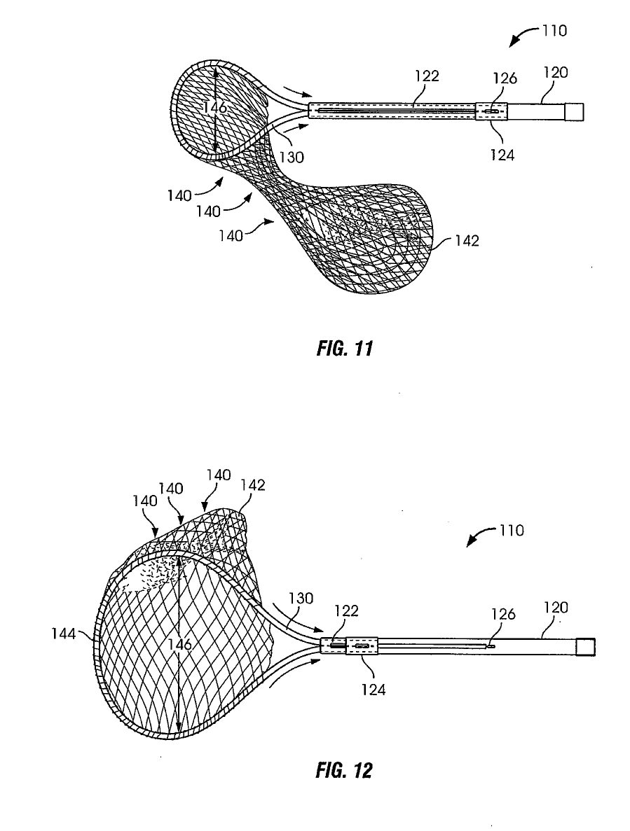

As the collar 124 coupled to at least one end of the resilient frame portion 130 slides along the handle portion 120, one or both of the ends of the resilient frame portions 130 may be drawn into and/or through the handle channel 122 when the collar 124 slides away from the resilient frame portion 130. For example, FIG. 11 illustrates that both ends of the resilient frame portion 130 may couple to the collar 124. Accordingly, when the collar 124 slides away from the resilient frame portion 130 protruding from the handle portion 120, both ends of the resilient frame portion 130 may be drawn into and/or through the handle channel 122 of the handle portion 120 to configure the net assembly 110 is in the closed configuration. FIG. 12 illustrates the net of FIG. 11 in the open configuration for which the collar 124 is slid toward the resilient frame portion 130.

Alternatively, FIG. 9 illustrates that only one end of the resilient frame portion 130 may couple to the collar 124 while the other end may couple directly to the handle portion 120 (e.g., within the handle channel 122, to the end of the handle portion 120, and/or to the exterior of the handle portion 120. Accordingly, when the collar 124 slides away from the resilient frame portion 130 protruding from the handle portion 120, one end of the resilient frame portion 130 may be drawn into and/or through the interior handle channel 122 of the handle portion 120 to configure the net assembly 110 in the closed configuration. FIG. 10 illustrates the net of FIG. 9 in the open configuration for which the collar 124 is slid toward the resilient frame portion 130.

For either embodiment, when one or both ends of the resilient frame portion 130 are drawn into and/or through the handle channel 122, the length of the resilient frame portion 130 that protrudes from the handle portion 120 and defines the net aperture 146 shortens, in turn constricting or otherwise decreasing the size of the net aperture 146 so that the net assembly 110 is in the closed configuration. Conversely, when one or both ends of the resilient frame portion 130 are extruded from the handle channel 122, the length of the resilient frame portion 130 that protrudes from the handle portion 120 and defines the net aperture 146 lengthens, in turn dilating or otherwise increasing the size of the net aperture 146 so that the net assembly 110 is in the open configuration.

The resilient frame portion 130 and/or the resilient loop portion 150 may be formed of any resilient material that may be flexible enough to be drawn into the handle channel 122 of the handle portion 120 while the net assembly 110 is in the closed configuration. Further, the resilient material may be flexible enough to constrict and/or reduce the size of the net aperture 146 when the net is in the closed configuration. However, the resilient material of an embodiment may also have sufficient resiliency and/or stiffness such that when the net assembly 110 is in the open configuration, the resilient frame portion 130 or the resilient loop portion dilates and/or expands the net aperture 146. Further, the resilient material of an embodiment may be resilient in the plane including the loop and/or net aperture 146 it forms while remaining substantially rigid in other planes. For example, the resilient material may be substantially rigid to substantially avoid deformation as a fish is releasably captured and removed from, for example, the water. In an embodiment, the resilient frame portion and/or the resilient loop portion 150 may be formed of a composite resilient material. For example, the composite resilient material may be glass fiber reinforced plastic, a glass fiber reinforced polymer, a carbon fiber reinforced plastic, a carbon fiber reinforced polymer, and/or a combination thereof.

The net assemblies 10 and 110 of embodiments as described above open and close manually by sliding the collar 22 or 124 along the handle portion 20 or 120 respectively. The net assemblies 10 and 110 may alternately or additionally be configured to open and/or close automatically. More specifically, the net assemblies 10 and 110 may include a mechanical (e.g., metal) spring or pressurized gas spring inside the handle portions 20 or 120 to automatically draw the resilient member 50 or resilient frame portion 130 into the handle or/or along the handle portions 20 and 120 respectively. The automatic closure can also be configured to be triggered by the weight of a fish, creature, or other object inside the net assembly 10 or 110, such that when the user nets a fish, creature, or other object, the weight on the fish, creature or other object may trigger the automatic closure to close the net assembly 10 or 110. The net assemblies 10 and 110 of embodiments may additionally or alternately be configured to open automatically such that the net assemblies 10 and 110 may be more conveniently stored in their closed configurations and quickly expanded to their open configurations.

Though described with reference to fishing, the net assemblies 10 and 110 of embodiments may further be used to releasably capture other animate or inanimate objects for which it would be useful to employ the net assemblies 10 and/or 110 of an embodiment including the closed configuration described above to decrease the likelihood that the animate or inanimate object releasably captured therein would escape or be otherwise inadvertently released. For example, the net assemblies 10 and 110 may include net apertures and net weave sizes that accommodate smaller animate objects such as insects, in particular flying insects such as butterflies, and the like.

Further, the net assemblies 10 and 110 may include a frame portion 30 or resilient frame portion 130 that protrudes from the handle portion 20 or 120 respectively at varying angles to accommodate the specific application of the net assembly 10 or 110. For example, should the net assembly 10 or 110 be used to pick fruit, for example from a tree, the frame portion 30 or resilient frame portion 130 may protrude from the handle portion 20 or 120 respectively at approximately 90 degrees to improve the ease with which the fruit may be collected. Other angles are contemplated to improve the ability with the net assemblies 10 and 110 may be used to collect fruit from trees or the like depending on the height of the fruit and/or height of the fruit collector. Further, the angle may be adjustable to configure the net assembly 10 or 110 for a specific fruit picking task. As noted above, the net apertures and net weave sizes may be adjusted depending on the size of the fruit to be collected.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A net comprising:
a handle portion;
a frame portion coupled to the handle portion;
a net portion coupled to the frame portion, the net portion defining a net aperture; and
a resilient member coupled to the net portion to adjust the size of the net aperture.

2. The net of claim 1, further comprising a collar coupled to the resilient member and slidably engaged to the handle portion, the collar to slidably engage the handle portion at a first position to configure the net in an open configuration

3. The net of claim 2, the net aperture to substantially dilate with the net in the open configuration.

4. The net of claim 2, the collar to slidably engage the handle portion at a second position to configure the net in a closed configuration.

5. The net of claim 4, the net aperture to substantially constrict with the net in the closed configuration

6. The net of claim 4 further comprising a locking member coupled to the handle portion to detachably engage the collar at the second position.

7. A method of netting a fish, comprising:
configuring a fish net in an open configuration, the fish net including a handle, a frame coupled to the handle, and a net bag coupled to the frame;
releasably capturing a fish within the fish net; and
configuring the fish net to a closed position to substantially impede the fish from escaping the fish net.

8. The method of claim 7, configuring the net in the open configuration further comprising sliding a collar coupled to the handle toward the frame.

9. The method of claim 7, configuring the net in the closed configuration further comprising sliding a collar coupled to the handle away from the frame.

10. The method of claim 9 further comprising detachably engaging the collar to a locking member coupled to the handle to substantially lock the net in the closed configuration.

11. A fish enclosing net apparatus, comprising:
means for netting a fish including a net opening through which a fish is netted; and
means for tightening a net opening to a small size to retard fish ability to escape;

12. A fish enclosing net apparatus, comprising:
a fish netting hand net for netting a fish having a net and a handle; and
a net opening tightener retractable into said handle allowing the user to tighten the opening as needed to prevent the fish from escaping.

13. The fish enclosing net apparatus of claim 12, wherein the net opening tightener is a flexible rim around which said net is strung, said rim having two ends, at least one of which can be retractably pulled into a handle.

14. The fish enclosing net apparatus of claim 13, wherein both ends of the rim can be pulled into a handle.

15. The fish enclosing net apparatus of claim 12, further comprising a rim attached to said handle upon which the net is strung, and wherein the net opening tightener is a cable which loops through said net strung on said rim, said cable having two ends, at least one of which can be retractably pulled into a handle.

16. The fish enclosing net apparatus of claim 15, wherein both ends of the cable can be pulled into a handle.

17. The fish enclosing net apparatus of claim 15, wherein the cable is coiled one loop through the net stung on said rim, such that drawing said cable ends into the handle tightens the looped coil of the cable, further closing the net opening.
